(19) United States
(12) Patent Application Publication
(10) Pub. No.: US 2018/0033012 A1
(43) Pub. Date: Feb. 1, 2018

(54) SYSTEM AND METHOD FOR PRESENTING TARGETED IN STORE COUPON AND ADVERTISEMENT TO CUSTOMER BASED ON THEIR TRANSACTION HISTORY

(71) Applicant: MASTERCARD INTERNATIONAL INCORPORATED, PURCHASE, NY (US)

(72) Inventor: Manoneet Kohli, O'Fallon, MO (US)

(73) Assignee: MASTERCARD INTERNATIONAL INCORPORATED, PURCHASE, NY (US)

(21) Appl. No.: 15/221,487

(22) Filed: Jul. 27, 2016

(51) Int. Cl. G06Q 20/40; G06Q 30/02; G06Q 20/34

(52) U.S. Cl. CPC G06Q 20/40145; G06Q 20/34; G06Q 30/0259; G06Q 30/0269; G06Q 30/0277; G06Q 30/0239; G06Q 30/0222; G06Q 30/0255

(57) ABSTRACT

Method for presenting targeted messages can include initiating a transaction with a cardholder to purchase an item. The merchant can receive a selection from the cardholder to obtain the item at a merchant location. The merchant can also receive information identifying a customer who will obtain the item at the merchant location. At the merchant location, the merchant can verify an identity of the customer based at least in part on the information identifying the customer, and the merchant can provide the item to the customer. The merchant can also present a targeted message to the customer at the merchant location based on a customer profile corresponding to the customer. Systems, networks, and media are also disclosed.

### BACKGROUND

The disclosed subject matter relates to methods, systems, networks, and media for presenting targeted messages to a customer, including presenting targeted advertising or coupons to a customer at a merchant location.

Merchants such as retailers, store owners, and event venue operators can face challenges in presenting targeted marketing messages such as advertisements or coupons for their products or services to a customer when that customer is at each merchant's location. For example, the merchants can lack sufficient profiling of the customer and/or information regarding the customer's purchase history to accurately select which marketing messages to present to the customer while the customer is in-store or otherwise at the merchant's location. This lack of targeted marketing can result in a lost opportunity to sell additional products or services to the customer and a resulting decrease in visit conversion for the merchant.

Techniques for presenting in store advertising that are general or not customer-specific are known. These existing techniques can include posters, flyers, coupon books, speakers playing audio recordings or announcements, and video displays presenting video advertisements or information regarding current discount offers. Additionally, some merchants can have customer loyalty programs where customers sign up and then present a card, account number, or other identifying information (e.g., phone number or email address) during checkout at the merchant location. While such loyalty programs can allow a merchant to track a customer's purchase history with that merchant, they can lack other useful information about the customer and/or information about the customer's purchase history at other merchants.

Accordingly, there exists a need for improved techniques for presenting targeted messages to a customer, including presenting targeted advertising or coupons to a customer in a merchant location based on a customer profile.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, a method for presenting targeted messages is disclosed. The method can include initiating a transaction with a cardholder to purchase an item. A selection can be received from the cardholder to obtain the item at a merchant location. Information identifying a customer who will obtain the item at the merchant location can be received. At the merchant location, an identity of the customer can be verified based at least in part on the information identifying the customer. At the merchant location, the item can be provided to the customer. At the merchant location, a targeted message can be presented to the customer based on a customer profile corresponding to the customer.

As embodied herein, the customer can be the cardholder. Alternatively, the cardholder and the customer can be different individuals. Additionally, each of the cardholder and the customer can have an account with at least one of a same issuer or a same service provider.

For the purpose of illustration and not limitation, initiating the transaction can include receiving transaction information from the customer over an electronic network. For example, the transaction information can be received from the customer via a merchant website over the internet. Additionally or alternatively, initiating the transaction can include receiving transaction information from the customer over a telephone network using one of mail order, telephone order or interactive voice response. Alternatively, initiating the transaction can include initiating a transaction at a merchant terminal, and receiving the selection from the cardholder to obtain the item at the merchant location can include receiving a selection to obtain the item at a later time. Additionally, the merchant terminal can be at a second merchant location different than the first merchant location, or the merchant terminal can be at the same merchant location.

As embodied herein, the transaction can be approved by transmitting an authorization request over a payment network and receiving a corresponding authorization response over the payment network. Additionally, the cardholder can be provided with an option to obtain the item in-store before the selection is received.

For the purpose of illustration and not limitation, the customer can be enrolled based at least in part on the information identifying the customer. For example, biometric challenge information can be obtained from the customer using a customer device, an issuer device, a service provider device, or a merchant device, and the biometric challenge information can be stored. As embodied herein, the biometric challenge information can include at least one of a fingerprint, a photograph, a voice recording, or an iris scan. Additionally, the customer can be enrolled before arriving at the merchant location where the customer's identity will be verified.

As embodied herein, verifying the identity of the customer can include requesting the customer to provide the information identifying the customer at a merchant device. The information identifying the customer can be received at the merchant device. For example and not limitation, the stored biometric challenge information corresponding to the customer can be obtained from at least one of a service provider or an issuer, and the merchant device can request the customer to provide the biometric challenge information. The biometric challenge information from the customer can be received at the merchant device and the received biometric challenge information can be compared with the stored biometric challenge information to verify the identity of the customer. Additionally or alternatively, the merchant device can receive the biometric challenge information via the customer device over an electronic network.

For the purpose of illustration and not limitation, the item can be provided to the customer using a merchant device. Alternatively, a merchant employee or personnel can provide the item to the customer.

As embodied herein, the targeted message can include at least one of an advertisement or a coupon selected based on the customer profile. For example and not limitation, the targeted message can be presented to the customer by at least one of displaying the targeted message on a customer device, displaying the targeted message on a merchant device, printing the targeted message for the customer at the merchant device, or contacting at least one merchant employee to present the targeted message to the customer. For the purpose of illustration and not limitation, the customer profile can include at least one of a customer age, a customer sex, a customer occupation, and a customer purchase history.

For the purpose of illustration and not limitation, the customer profile can be obtained from at least one of a service provider or an issuer before presenting the targeted message to the customer based on the customer profile. Additionally, the service provider or issuer can update the customer profile automatically each time the customer makes a transaction.

For example and not limitation, the customer can be directed to the merchant to make a transaction corresponding to the targeted message. Additionally or alternatively, the customer profile can be updated based on whether the customer makes (or does not make) a transaction corresponding to the targeted message.

For the purpose of illustration and not limitation, the item can be an article or product. Alternatively, the item can be an admission to an event, and providing the item to the customer can include admitting the customer to the event.

In accordance with another aspect of the disclosed subject matter, a system for presenting targeted messages is disclosed. The system can include a merchant computer system, which can be configured to initiate a transaction with a cardholder to purchase an item, receive a selection from the cardholder to obtain the item at a merchant location, and receive information identifying a customer who will obtain the item at the merchant location. A merchant device at the merchant location can be configured to verify an identity of the customer based at least in part on the information identifying the customer, provide the item to the customer, and present a targeted message to the customer based on a customer profile corresponding to the customer.

As embodied herein, the merchant computer system can be connected to a payment network, and the merchant computer system can be further configured to generate an authorization request corresponding to the transaction with the cardholder, transmit the authorization request over the payment network, and receive an authorization response corresponding to the authorization request. Additionally or alternatively, the merchant computer system can be connected to a first network (e.g., the internet), and the merchant computer system can be further configured to initiate the transaction with a cardholder device of the cardholder over the first network. Additionally, the merchant device and the customer device can be connected to the first network. Alternatively, the merchant device and the customer device can be connected to a second network, (e.g., a wired connection or wireless network such as a wireless local area network (WLAN) or wireless personal are network (WPAN)). As embodied herein, the merchant device can be further configured to transmit a request over the (first or second) network to a customer device of the customer for the customer to provide the information identifying the customer and receive the information identifying the customer from the customer device.

For the purpose of illustration and not limitation, the merchant device can be further configured to verify the identity of the customer based at least in part on biometric challenge information corresponding to the information identifying the customer. For example, a service provider server can be configured to store biometric challenge information corresponding to the information identifying the customer, and further the merchant device can be further configured to obtain the stored biometric challenge information from the service provider server corresponding to the information identifying the customer. Additionally, the merchant device can be further configured to compare biometric challenge information received from a customer device to the stored biometric challenge information corresponding to the information identifying the customer obtained from the service provider server to verify the identity of the customer.

As embodied herein, the merchant device can be configured to obtain the customer profile from a service provider server over at least one of a first network or a payment network. Additionally or alternatively, the merchant device can be further configured to transmit the targeted message to a customer device to present the targeted message to the customer. For example, the customer device can be configured to display the targeted message.

In accordance with another aspect of the disclosed subject matter, a network for presenting targeted messages is disclosed. The network can include a cardholder device of a cardholder. A merchant computer system can be configured to initiate a transaction with a cardholder device to purchase an item, receive a selection from the cardholder device to obtain the item at a merchant location, and receive from the cardholder device information identifying a customer who will obtain the item at the merchant location. The customer can have a customer device. A merchant device at the merchant location can be configured to verify an identity of the customer based at least in part on the information identifying the customer and information from the customer device, provide the item to the customer, and provide a targeted message to the customer device based on a customer profile corresponding to the customer. The customer device can be configured to present the targeted message to the customer.

As embodied herein, the merchant computer system can be connected to the cardholder device over a first network and the merchant device can be connected to the customer device over at least one of the first network or a second network. Additionally or alternatively, the merchant computer system can be further configured to generate an authorization request corresponding to the transaction with the cardholder and transmit the authorization request over a payment network. At least one acquirer can be connected to the payment network, and the merchant computer system can be in communication with at least one of the acquirer(s) via the payment network. At least one issuer can be connected to the payment network, and each acquirer can be in communication with at least one of the issuer(s) via the payment network. The issuer(s) can be configured to receive the authorization request over the payment network and transmit a corresponding authorization response over the payment network. At least one service provider server can be connected to the payment network and configured to automatically store purchase information corresponding to each authorization request and corresponding authorization response over the payment network and to update a corresponding customer profile with the purchase information.

For the purpose of illustration and not limitation, the customer device can be configured to obtain biometric challenge information, and the information provided from the customer device to the merchant device can include the biometric challenge information. Additionally, a service provider server can be configured to store biometric challenge information corresponding to the information identifying the customer. The merchant device can be further configured to obtain the stored biometric challenge information from the service provider server corresponding to the information identifying the customer. The merchant device can be further configured to obtain the customer profile from a service provider server. Additionally or alternatively, the service provider server can be configured to update the customer profile automatically each time the customer makes a transaction.

For the purpose of illustration and not limitation, the customer device can be configured to display the targeted message to the customer.

In accordance with another aspect of the disclosed subject matter, a non-transitory computer readable medium is disclosed. The non-transitory computer readable medium can include an executable set of instructions to direct a processor to initiate a transaction with a cardholder to purchase an item. A selection can be received from the cardholder to obtain the item at a merchant location. Information identifying a customer who will obtain the item at the merchant location can be received. At the merchant location, an identity of the customer can be verified based at least in part on the information identifying the customer. The item can be provided to the customer. A targeted message can be presented to the customer at the merchant location based on a customer profile corresponding to the customer.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a diagram illustrating a representative payment network according to an illustrative embodiment of the disclosed subject matter.

FIGS. 2A-D are block diagrams illustrating exemplary uses of a representative customer device according to an illustrative embodiment of the disclosed subject matter.

FIGS. 3A-B are block diagrams illustrating exemplary uses of a representative merchant device according to an illustrative embodiment of the disclosed subject matter.

FIG. 4 is a flow chart illustrating a representative method implemented according to an illustrative embodiment of the disclosed subject matter.

FIG. 5 is a block diagram illustrating further details of a representative computer system according to an illustrative embodiment of the disclosed subject matter.

Throughout the drawings, the same reference numerals and characters, unless otherwise stated, are used to denote like features, elements, components or portions of the illustrated embodiments. Moreover, while the present disclosed subject matter will now be described in detail with reference to the figures, it is done so in connection with the illustrative embodiments.

### DETAILED DESCRIPTION

Reference will now be made in detail to the various exemplary embodiments of the disclosed subject matter, some of which are illustrated in the accompanying drawings. The structure and corresponding method of operation of the disclosed subject matter will be described in conjunction with the detailed description of the system.

The methods, systems, networks, and media presented herein can be used for presenting targeted messages. The disclosed subject matter is particularly suited for presenting a targeted message to a customer based on a customer profile. For the purpose of illustration and not limitation, the customer profile can include at least one of a customer age, a customer sex, a customer occupation, and a customer purchase history. For example, the targeted messages can be selected based on the information included in the customer profile. Additionally, as embodied herein, identifying information that is unique to the customer can be used to verify the identity of the customer to ensure that customer is accurately identified and the correct customer profile is used to select the targeted message. For example, biometric challenge information or other unique identifying information can be used to verify the identity.

As discussed herein, certain merchants can lack sufficiently accurate customer profile information to select appropriate targeted messages to display to a customer. Additionally, certain identifying information (e.g., phone numbers, email addresses, User IDs, or passwords) can be shared among customers, which can result in the identifying information not accurately identifying the customer who enters it. The disclosed subject matter can enable accurately identifying a customer and presenting targeted messages to the customer at a merchant location based on a customer profile, as discussed herein. Additionally, the disclosed subject matter leverages merchant data collected by payment network service providers to allow the service providers or other entities (e.g., merchants) to automatically update the customer profile as the customer makes transactions to ensure the accuracy of the customer profile. Accordingly, the disclosed subject matter provides an advantage by presenting messages that are targeted at the customer. Such targeted messaged can be used, for example and not limitation, to increase the likelihood that the customer will purchase additional products at the merchant location. For the purpose of illustration and not limitation, the payment network service provider can use the disclosed subject matter to provide merchants with updated customer identifying information and customer profiles to help the merchants present the targeted messages to the customers.

In accordance with the disclosed subject matter herein, a method for presenting targeted messages is disclosed. The method can include initiating a transaction with a cardholder to purchase an item. A selection can be received from the cardholder to obtain the item at a merchant location. Information identifying a customer who will obtain the item at the merchant location can be received. At the merchant location, an identity of the customer can be verified based at least in part on the information identifying the customer. At the merchant location, the item can be provided to the customer. At the merchant location, a targeted message can be presented to the customer based on a customer profile corresponding to the customer.

In accordance with another aspect of the disclosed subject matter, a system for presenting targeted messages is disclosed. The system can include a merchant computer system, which can be configured to initiate a transaction with a cardholder to purchase an item, receive a selection from the cardholder to obtain the item at a merchant location, and receive information identifying a customer who will obtain the item at the merchant location. A merchant device at the merchant location can be configured to verify an identity of the customer based at least in part on the information identifying the customer, provide the item to the customer, and present a targeted message to the customer based on a customer profile corresponding to the customer.

In accordance with another aspect of the disclosed subject matter, a network for presenting targeted messages is disclosed. The network can include a cardholder device of a cardholder. A merchant computer system can be configured to initiate a transaction with a cardholder device to purchase an item, receive a selection from the cardholder device to obtain the item at a merchant location, and receive from the cardholder device information identifying a customer who will obtain the item at the merchant location. The customer can have a customer device. A merchant device at the merchant location can be configured to verify an identity of the customer based at least in part on the information identifying the customer and information from the customer device, provide the item to the customer, and provide a targeted message to the customer device based on a customer profile corresponding to the customer. The customer device can be configured to present the targeted message to the customer.

In accordance with another aspect of the disclosed subject matter, a non-transitory computer readable medium is disclosed. The non-transitory computer readable medium can include an executable set of instructions to direct a processor to initiate a transaction with a cardholder to purchase an item. A selection can be received from the cardholder to obtain the item at a merchant location. Information identifying a customer who will obtain the item at the merchant location can be received. At the merchant location, an identity of the customer can be verified based at least in part on the information identifying the customer. The item can be provided to the customer. A targeted message can be presented to the customer at the merchant location based on a customer profile corresponding to the customer.

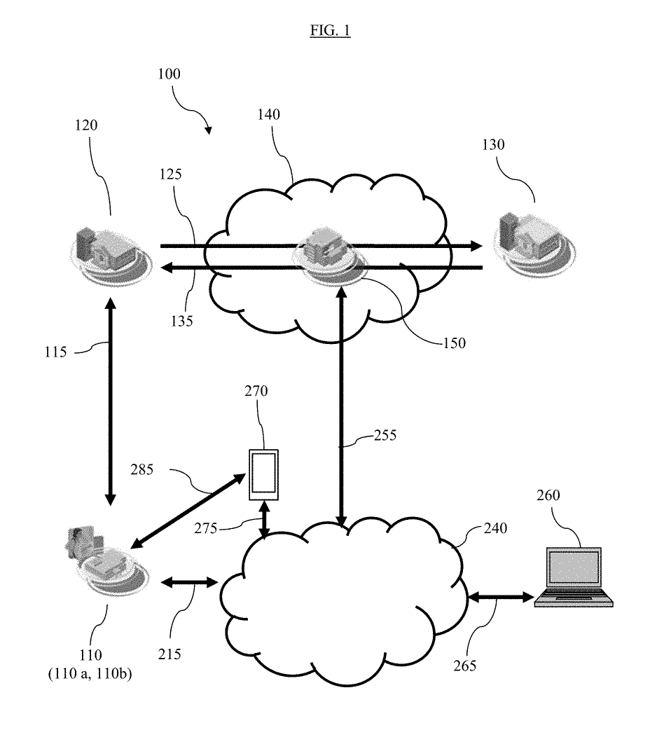

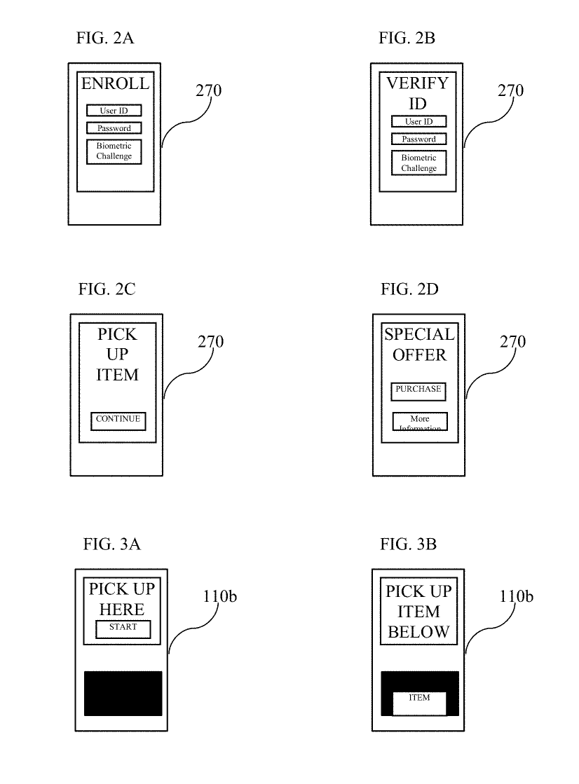

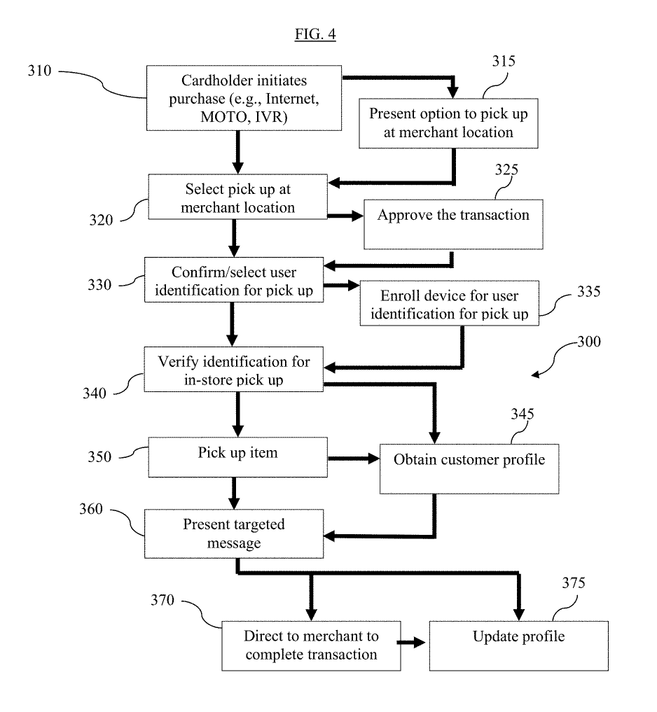

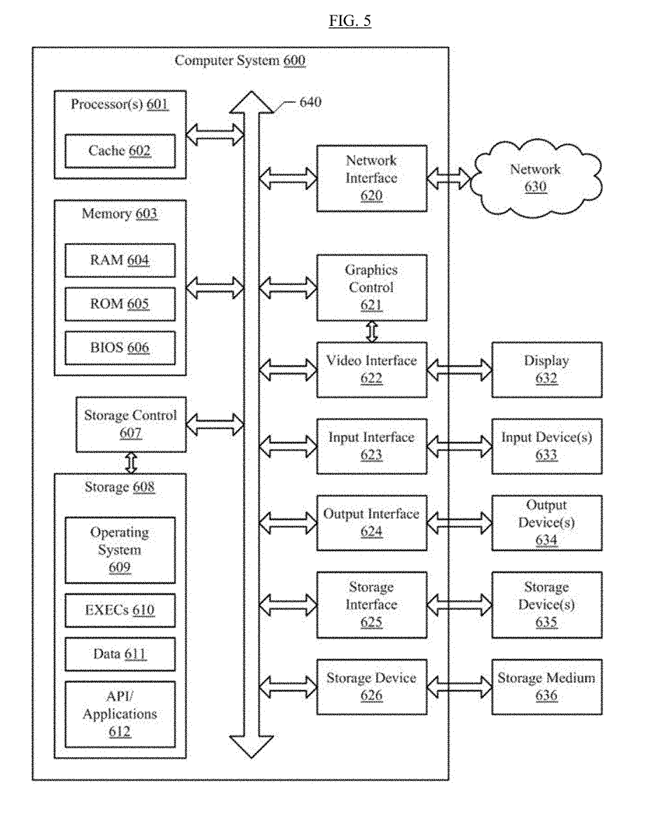

The accompanying figures, where like reference numerals refer to identical or functionally similar elements throughout the separate views, further illustrate various embodiments and explain various principles and advantages all in accordance with the disclosed subject matter. For the purpose of explanation and illustration, and not limitation, an exemplary embodiment of a network for presenting targeted messages in accordance with the disclosed subject matter is shown in FIG. 1. An exemplary embodiment of a customer device for use in a system for presenting targeted messages in accordance with the disclosed subject matter is shown in FIGS. 2A-D, and an exemplary embodiment of a merchant device for use in a system for presenting targeted messages in accordance with the disclosed subject matter is shown in FIGS. 3A-B. FIG. 4 shows an exemplary embodiment of a method for presenting targeted messages in accordance with the disclosed subject matter. An exemplary embodiment of a computer system for use with the disclosed subject matter is shown in FIG. 5. While the present disclosed subject matter is described with respect to using methods, systems, networks, and media for presenting targeted advertising or coupons to a customer in a merchant location, one skilled in the art will recognize that the disclosed subject matter is not limited to the illustrative embodiments. For example, the methods, systems, networks, and media for presenting targeted messages can be used with a wide variety of settings, such as presenting targeted messages to an individual wherever such an individual would normally be required or encouraged to validate the individual's identity.

FIG. 1 depicts a diagram illustrating a representative network 100 according to an illustrative embodiment of the disclosed subject matter. The network 100 can include payment network 140, which can allow for payment transactions in which merchants and card issuers do not necessarily have a one-to-one relationship. The payment network 140, for example and without limitation, can be a credit card payment system and can utilize an electronic payment network such as the MasterCard® payment card system interchange network. MasterCard® payment card system interchange network is a proprietary communications standard promulgated by MasterCard International Incorporated® based on the ISO 8583 message format for the exchange of financial transaction data between financial institutions that are customers of MasterCard International Incorporated. (MasterCard is a registered trademark of MasterCard International Incorporated located in Purchase, N.Y.)

As embodied herein, the network 100 for presenting targeted messages can include at least one merchant 110 connected to at least one electronic payment network 140, either directly or through an acquirer 120 via connection 115. At least one acquirer 120 can be connected to the electronic network 140, and each merchant 110 can be in communication with at least one acquirer 120 via the at least one payment network 140 or connection 115. At least one issuer 130 can be connected to the electronic network 140, and each acquirer 120 can be in communication with at least one issuer 130 via the electronic payment network 140.

For the purpose of illustration and not limitation, in payment network 140, a financial institution, such as an issuer 130, can issue an account, such as a credit card account or a debit card account, to a cardholder (e.g., an individual consumer or a corporate or commercial customer), who can use the payment account card to tender payment for a purchase from a merchant 110 or to conduct a transaction at an ATM or website. To accept payment with the payment account card, merchant 110 can establish an account with a financial institution that is part of the financial payment system. This financial institution can be referred to as the “merchant bank” or the “acquiring bank,” or herein as “acquirer 120.” When a cardholder tenders payment for a purchase with a payment account card, the merchant, ATM, or website 110 can request authorization from acquirer 120 for the amount of the purchase. The transaction can be performed over the telephone, online via a website, or through the use of a point-of-sale terminal which can read the cardholder's account information from the magnetic stripe on the payment account card, from a smart card using contact pads, or contactlessly from a near-field communication device and communicate electronically with the transaction processing computers of acquirer 120. Alternatively, acquirer 120 can authorize a third party to perform transaction processing on its behalf. In this case, the point-of-sale terminal can be configured to communicate with the third party. Such a third party can be referred to as a “merchant processor” or an “acquiring processor.”

As embodied herein, using payment network 140, the computers of acquirer 120 or the merchant processor can communicate information regarding payment card transactions with computers of the issuer 130. For example and not limitation, information regarding payment card transactions can include an authorization request 125 and an authorization response 135. An authorization request 125 can be communicated from the computers of the acquirer 120 to the computers of issuer 130 to determine whether the cardholder's account is in good standing and whether the purchase is covered by the cardholder's available credit line or account balance. Based on these determinations, the authorization request 125 can be declined or accepted, and an authorization response 135 can be transmitted from the issuer 130 to the acquirer 120, and then to the merchant, ATM, or website 110. The authorization request 125 can include account information identifying the merchant, location information (e.g., an address of the merchant), and transaction information, as discussed herein. The authorization response 135 can include, among other things, a result of the determination that the transaction is approved or declined and/or information about the status of the payment card or payment account.

For example and not limitation, at least one service provider network server 150 can be connected to the electronic payment network 140 and configured to automatically store purchase information corresponding to each authorization request 125 and corresponding authorization response 135 over the payment network 140. The service provider network server 150 can update a corresponding customer profile with the purchase information. Additionally, the service provider server 150 can be connected to at least one other network. For example and not limitation, service provider 150 can be connected to first network 240 by a connection 255. Additionally or alternatively, the acquirer 120 and/or the issuer 130 can be connected to the first network 240 (not shown). For example and not limitation, the first network 240 can be the internet or any other suitable network, including by not limited to a telephone network, a dedicated link, a local area network (LAN) (e.g., a wireless local area network (WLAN)), a personal area network (PAN) (e.g., a wireless personal area network (WPAN)), or the like, as described herein. As embodied herein, the service provider server 150 can be configured to only capture the purchase information related to payment card transactions with the permission of the cardholder. Additionally, the payment network server 150 can be configured to only capture the information regarding payment card transactions in accordance with applicable data privacy laws.

For the purpose of illustration and not limitation, the merchant 110 can include a merchant computer system 110a and a merchant device 110b, as described herein. The merchant 110 can be connected to the first network 240 by a connection 215. Additionally, a cardholder device 260 of a cardholder can be connected to the first network 240 by a connection 265. The cardholder device 260 can be any suitable device, including but not limited to a personal computer such as a desktop computer or laptop computer, a mobile device such as a smartphone or tablet, or a telephone. For example, as depicted in FIG. 1, the cardholder device 260 can be a personal computer. The merchant computer system 110a can initiate a transaction with a cardholder device 260 to purchase an item. The merchant computer system 110a also can receive a selection from the cardholder device 260 to obtain the item at a merchant location (e.g., a merchant device 110b at the merchant location). Additionally, the merchant computer system 110a can receive from the cardholder device 260 information identifying a customer who will obtain the item at the merchant location. As described herein, the customer can be the same as the cardholder or different. Additionally or alternatively, both the customer and the cardholder can have an account with the same issuer or service provider, as described herein.

As embodied herein, the customer can have a customer device 270. The customer device 270 can be any suitable device, including but not limited to a computer such as a desktop computer or laptop computer, a mobile device such as a smartphone or tablet, or a telephone. As depicted in FIG. 1, the customer device 270 can be a mobile device. As described herein, the customer device 270 can be the same or different than the cardholder device 260. The customer device 270 can be connected to the first network 240 by a connection 275. Additionally or alternatively, the customer device 270 can be connected directly to the merchant device 110b at the merchant location by a connection 285. The connection 285 can be any suitable connection including a wired or wireless connection. For example and not limitation, the connection 285 can be a second network such as a WLAN or a WPAN.

For the purpose of illustration and not limitation, a merchant device 110b at the merchant location can verify an identity of the customer based at least in part on the information identifying the customer and information from the customer device 270, as described herein. Additionally, the merchant device 110b can provide the item to the customer, as described herein. The merchant device 110b also can present a targeted message to the customer device 270 based on a customer profile corresponding to the customer, as described herein. For example and not limitation, the merchant device 110b can present the targeted message to the customer device 270, which can present the targeted message to the customer, as described herein.

As embodied herein, the merchant device 110b can use information from the customer device 270 that is unique to the customer to verify the customer's identity, as described herein. For the purpose of illustration and not limitation, the customer device 270 can obtain biometric challenge information from the customer. The information from the customer device used by the merchant device 110b to verify the customer's identity can include the biometric challenge information. For example and not limitation, the customer can be enrolled prior to the time for verifying the customer's identity at the merchant location, and part of the enrollment can include providing the biometric challenge information to a service provider or issuer. As embodied herein, a service provider server 150 can store biometric challenge information corresponding to the information identifying the customer (e.g., the customer's User ID selected during enrollment). The merchant device 110b can obtain the stored biometric challenge information from the service provider server 150 corresponding to the information identifying the customer. The stored biometric challenge information can be compared to biometric challenge information provided by the customer device 270 at the merchant location, and the customer's identity can be verified if the stored biometric challenge information matches the provided biometric challenge information, as described herein.

Additionally or alternatively, merchant device 110b can obtain the customer profile corresponding to the information identifying the customer from a service provider server 150. For example and not limitation, the service provider server 150 can update the customer profile automatically each time the customer makes a transaction. The customer profile can be used by the merchant device 110b to select the targeted message to be displayed to the customer, as described herein. For example and not limitation, the customer device 270 can display the targeted message to the customer.

FIGS. 2A-D are block diagrams illustrating exemplary uses of a representative customer device according to an illustrative embodiment of the disclosed subject matter. For the purpose of illustration and not limitation, FIG. 2A depicts an exemplary customer device 270 during enrollment. For example and not limitation, the customer can already have an account with the service provider, and the account can have a corresponding to a User ID and password. As embodied herein, during enrollment, the customer device 270 can be used to collect and/or select any information suitable for identifying the customer, for example and not limitation, the customer's User ID, password, and biometric challenge information. Additionally, the service provider server 150 can store the provided identifying information and associate that information with other information associated with the account, for example, the customer profile. FIG. 2B depicts the exemplary customer device 270 during verification of the customer's identity at the merchant location. For example and not limitation, the customer use the customer device 270 to input the biometric challenge information again at the time of verification so that the merchant device 110b can compare the information with the stored biometric challenge information. FIG. 2C depicts the exemplary customer device 270 after the customer's identity is validated and the customer is provided the item. FIG. 2D depicts the exemplary customer device 270 displaying the targeted message to the customer, as described herein.

FIGS. 3A-B are block diagrams illustrating exemplary uses of a representative merchant device according to an illustrative embodiment of the disclosed subject matter. For the purpose of illustration and not limitation, FIG. 3A depicts an exemplary merchant device 110b at the merchant location before the customer initiates the verification of the customer's identity. For example, the customer can select the option to start the verification, and the merchant device 110b can communicate with the customer device 270 to request the information identifying the customer, as described herein. Alternatively, the customer can provide the information directly to the merchant device 110b. For example, the merchant device 110b can include suitable input devices for the customer to enter the customer's User ID and other information identifying the customer, such as biometric challenge information, as described herein. FIG. 3B depicts the exemplary merchant device 110b after the customer's identity has been verified and the item is provided to the customer, as described herein.

FIG. 4 is a flow chart illustrating a representative method 300 implemented according to an illustrative embodiment of the disclosed subject matter. The exemplary network 100 of FIG. 1, customer device 270 of FIGS. 2A-B, and merchant device 110b of FIGS. 3A-B, for the purpose of illustration and not limitation, are discussed with reference to the exemplary method of FIG. 4.

As embodied herein, at 310, a cardholder initiates a transaction with the merchant. For the purpose of illustration and not limitation, the cardholder can use the cardholder device 260 to connect with the merchant computer system 110a over the first network 240. For example, the first network 240 can be the internet and the cardholder can use the cardholder device 260 to access a merchant website associated with the merchant computer system 110a. The transaction information from the customer over the electronic network comprises receiving the transaction information from the customer via a merchant website over the internet. Alternatively, the first network 240 can be a telephone network and transaction information from the customer can be received using one of mail order, telephone order or interactive voice response. As a further alternative, the cardholder can initiate a transaction at a merchant terminal, and the cardholder can select to obtain the item at the merchant location at a later time. For example, the merchant terminal can be at a second merchant location different than the first merchant location, or the merchant terminal can be at the same merchant location.

For the purpose of illustration and not limitation, at 315, the cardholder can be presented with an option to obtain the item at the merchant location before the receiving the selection from the cardholder to obtain the item at the merchant location. Additionally or alternatively, at 320, the cardholder can select to obtain the item at a merchant location.

As embodied herein, at 325, the transaction can be approved. For example, the transaction can be approved by transmitting an authorization request 125 over a payment network 140 and receiving a corresponding authorization response 135 over the payment network 140, as described herein. As depicted in FIG. 4, the transaction can be approved after selecting pickup at a merchant location (320) and before identifying the customer for pickup (330). Alternatively, the transaction can be approved before selecting pickup at a merchant location (320) or after identifying the customer for pickup (330).

Additionally or alternatively, at 330, the cardholder can provide information identifying a customer who will obtain the item at the merchant location. For example, the cardholder can use cardholder device 260 to provide information identifying a customer, which can be any suitable information, including but not limited to a name, a phone number, an email address, or a User ID. Additionally, the merchant computer system 110a can receive the information identifying the customer over the first network 240. For the purpose of illustration and not limitation, the cardholder can be the same as the customer. As such, the cardholder can provide information identifying the cardholder as the customer and/or make a selection confirming that the cardholder will obtain the item (e.g., a button, check box, radio button, or the like). Alternatively, the cardholder and the customer can be different. For the purpose of illustration and not limitation, each of the cardholder and the customer can have an account with at least one of a same issuer or a same service provider, and the information identifying the customer can be a User ID that the customer uses with the issuer/service provider.

For the purpose of illustration and not limitation, at 335, the customer can be enrolled based at least in part on the information identifying the customer. As depicted in FIG. 4, the customer can be enrolled after identifying the customer for pickup (330) and before verifying the customer's identity at pickup (340). Alternatively, the customer can be enrolled at any time prior to verifying the customer's identity at pickup (340), including but not limited to before the cardholder initiates the transaction (310). For example and not limitation, the customer can be enrolled by obtaining biometric challenge information from the customer using a customer device 270, a merchant device 110b, an issuer device of the issuer 130, or a service provider device of the service provider 150, and the biometric challenge information can be stored, e.g., at the service provider server 150 or the issuer 130. For the purpose of illustration, as depicted in FIG. 2A, the customer can use the customer device 270 to enroll by entering information identifying the customer (e.g., User ID and password) and providing biometric challenge information. For example, the enrollment can be accomplished by an app or program installed or downloaded on the customer device 270. As embodied herein, the biometric challenge information can include at least one of a fingerprint, a photograph, a voice recording, or an iris scan. For example, the customer device 270 can have input devices 633 suitable to input the biometric challenge information.

Additionally or alternatively, an issuer 130 can have an issuer device at the issuer's location(s), and the issuer device(s) can have input devices 633 suitable to input the biometric challenge information. For example, the issuer 130 can have a subscription with the service provider, and the service provider can provide the issuer device to the issuer 130. When a customer enrolls at the issuer's location, the biometric challenge information can be transmitted from the issuer device to the issuer's computer system and/or to the service provider server 150 to be stored. Additionally or alternatively, a merchant 110 can have a merchant device, which can be provided by the service provider (e.g., as part of a subscription) and/or can be the same or separate from the merchant device 110b, and the biometric challenge information collected when a customer enrolls can be transmitted from the merchant device to the service provider server 150 to be stored. For example and not limitation, the enrollment at the merchant can be through a merchant terminal or cash register. Alternatively, the customer can access a service provider website or an issuer website using the customer device 270, and the customer can enroll through the website similar to enrolling using the app or program.

As embodied herein, enrolling the customer and storing the biometric challenge information can be a one-time activity that can be performed by the issuer 130 or the service provider 150 (on behalf of the issuer) before or at the time of issuing a payment card to the customer or at a later time as described herein. Additionally, the biometric challenge information can be used by the customer for other purposes, for example and without limitation, in a card not present (CNP) transaction. As embodied herein, the enrollment and the storing or biometric challenge information can be only with the permission of the cardholder and/or in accordance with applicable data privacy laws.

As discussed herein, biometric challenge information can provide increased confidence in the identity of the customer at the merchant location. Unlike other information identifying the customer which can be shared (e.g., User ID, QR code, telephone number, email address), the biometric challenge information can be unique to the customer. Additionally or alternatively, other forms of information identifying the customer that is unique to the customer can be used, for example and without limitation, a photo identification card (e.g., issued by the government, an issuer, or a service provider).

For example and not limitation, at 340, the identity of the customer can be verified at the merchant location based at least in part on the information identifying the customer. For example and not limitation, the verification can include the merchant device 110b requesting the customer to provide the information identifying the customer and receiving the information from the customer. For example, as depicted in FIG. 3A, the customer can provide the information identifying the customer and/or biometric challenge information directly to the merchant device 110b, as described herein. Alternatively, the customer can select the option to start the verification, and the merchant device 110b can communicate with the customer device 270 to request the information identifying the customer and/or biometric challenge information, as described herein. For example, as depicted in FIG. 2B, after receiving the request from the merchant device 110b to provide the information, the customer device 270 (e.g., through an app or programs installed thereon or through a web browser) can allow the user to input the identifying information including but not limited to User ID, password, and/or biometric challenge information. Additionally, the merchant device 110b can obtain stored identifying information (e.g., stored biometric challenge information corresponding to the customer's User ID) from the service provider server 150 or issuer 130, e.g., via payment network 140, first network 240, or any other suitable channel (e.g., phone, internet, or dedicated link). The merchant device 110b can receive the information identifying the customer and/or biometric challenge information (e.g., from the customer device 270) and compare the information to the stored information identifying the customer and/or biometric challenge information to confirm the customer's identity. Additionally or alternatively, a merchant employee or personnel can verify the identity using any suitable information unique to the customer, as described herein.

Alternatively, if the customer does not wish to enroll and/or if the verification fails, the customer's identity can be verified by alternative techniques. For example, the customer can present the payment card used to complete the transaction and/or photo identification to merchant employee or personnel.

As embodied herein, at 350, the item can be provided to the customer at the merchant location. For example, after the customer's identity is verified (340), as described herein, the merchant device 110b can release or otherwise provide the item to the customer, as described herein. For the purpose of illustration and not limitation, as depicted in FIG. 2C, the customer device 270 can inform the customer that the item can be picked up, and/or the merchant device 110b can provide the item to the customer, as depicted in FIG. 3B. The merchant device can provide the item using any suitable arrangement, including but not limited to conveying the item to the customer on a conveyor system, unlocking a container containing the item, or permitting access to an area designated for picking up items or viewing an event. Alternatively, a merchant employee or personnel can provide the item to the customer, for example, in response to a message or notification from the merchant device 110b that the customer's identity has been verified.

For the purpose of illustration and not limitation, a merchant device 110b can include input devices 633 suitable for inputting biometric challenge information to verify the customer's identity (340) and can have appropriate mechanisms to provide the item to the customer (350) once verified. For example, the customer can find the merchant device 110b at the merchant location and input the biometric challenge information, and the merchant device 110b can provide the item in response thereto.

Additionally or alternatively, the customer can enter a code (e.g., an order number) or identifying information (e.g., a username) into the merchant device 110b, or the merchant device 110b can detect the customer's proximity to the merchant device 110b, e.g., by detecting the presence of the customer device 270 and/or receiving geo-location information from the customer device 270. After the customer enters the code or identifying information and/or the merchant device 110b detects the proximity of the customer device 270, the merchant device can initiate a request for biometric challenge information through the customer device 270, as described herein, if the merchant device 110b is unattended. For the purpose of illustration and not limitation, the merchant device 110b can be configured to only detect the proximity of a customer device 270 if the customer device 270 has been enrolled as described herein. For example, after the customer inputs the biometric challenge information into the merchant device 110b or the customer device 270, the received biometric challenge information can be transmitted to a service provider server 150 to be compared to stored biometric challenge information of the customer, and if the stored biometric challenge information matches the provided biometric challenge information, as described herein, a message or signal indicating that the customer's identity has been verified can be transmitted from the service provider server 150 to the merchant device 110b.

Alternatively, the customer can initiate the biometric challenge through the customer device 270. For example and not limitation, the customer can input the biometric challenge information into the customer device 270, as described herein, and the customer device can transmit the received biometric challenge information to a service provider server 150 to be compared to stored biometric challenge information of the customer, and if the stored biometric challenge information matches the provided biometric challenge information, as described herein, a message or signal indicating that the customer's identity has been verified can be transmitted from the service provider server 150 to the merchant device 110b. Alternatively, the service provider server 150 can transmit a code or password to the customer device 270 to be displayed to the customer, and the customer can enter the code into the merchant device 110b. Upon the customer's inputting the code, the merchant device 110b can provide the item to the customer. Alternatively, a merchant employee or personnel can provide the item to the customer, for example, in response to a message or notification from the merchant device 110b that the customer's identity has been verified or in response to receiving other unique identifying information from the customer, such as a driver's license or other identifying information as described herein. For example, a merchant employee can match the identifying information against the information identifying the customer provided by the cardholder during the transaction, as described herein. Additionally or alternatively, after the merchant employee verifies the identity, the merchant employee can cause a merchant device 110b to release or otherwise provide the item to the customer, as described herein.

For example and not limitation, at 345, the merchant device 110b can obtain the customer profile from at least one of a service provider server 150 or an issuer 130 before presenting the targeted message (360) to the customer. The customer profile can be obtained over any suitable network, as described herein. For the purpose of illustration, the customer profile can be obtained after the merchant device 110b has verified the identity of the customer (340) or provided the item to the customer (350).

For the purpose of illustration and not limitation, at 360, a targeted message can be presented to the customer at the merchant location based on a customer profile corresponding to the customer. For example and not limitation, the targeted message comprises at least one of an advertisement or a coupon selected based on the customer profile, as described herein. Additionally, the targeted message can be presented to the customer using any suitable technique, including but not limited to displaying the targeted message on a customer device 270, displaying the targeted message on a merchant device 110b, printing the targeted message for the customer at the merchant device 110b, or contacting at least one merchant employee to present the targeted message to the customer. For the purpose of illustration, as depicted in FIG. 2D, the customer device 270 can display the targeted message to the customer, for example and without limitation, through an app or program on the customer device 270, a web browser, and email message, a text message, or a multimedia message. Additionally, the customer device 270 can present the customer with options regarding the targeted message, for example and not limitation, to make a purchase or receive additional information corresponding to the targeted message. Additionally or alternatively, where the targeted message includes a coupon or other discount offer, such offer can be for purchase at the merchant location at that time and/or later purchase either at the merchant location or through another channel (e.g., online via a merchant website available over the internet or other network).

As embodied herein, the customer profile can include any information useful for presenting a targeted message, including but not limited to at least one of a customer age, a customer sex, a customer occupation, and a customer purchase history. Purchase history can include, for example and without limitation, categories of purchases, prices of purchases, average purchase price for all transactions, average purchase price corresponding to merchant classification code (MCC), names or other information identifying items or services purchased, times of purchases, locations of purchases, context of purchases (e.g., at an event or while traveling), or the like. Additionally or alternatively, the customer profile can include an indication of the amount of funds or amount of credit available to the customer, and the targeted message can correspond to the amount of funds/credit available, e.g., a coupon for a product with a price less than or equal to the available funds/credit. Additionally, at least one of the service provider server 150 or the issuer 130 can update the customer profile automatically each time the customer makes a transaction. The targeted message can be selected based on one or more pieces of information available in the customer profile. Additionally or alternatively, the targeted message can be selected based on an algorithm or combination using various pieces of information available in the customer profile.

For the purpose of illustration and not limitation, a hypothetical customer can make a purchase that can be stored in customer profile as part of the purchase history, and the targeted message can be presented based on the purchase. For example, if a customer previously purchased a copy of a movie, a targeted message can include a coupon or discount offer to buy a copy of a sequel to that movie and/or items related to movie purchases including but not limited to snacks (e.g., popcorn or candy) or beverages.

Additionally or alternatively, the item purchased by a hypothetical cardholder can be an admission ticket to an event, and providing the item to the customer can include admitting the customer to the event after verifying the customer's identity, as described herein. Based on the customer profile, a targeted message can include advertising for other events or coupons for event-related items. For example, if the customer has previously purchased a t-shirt at a previous event, the targeted message can be a coupon to purchase a t-shirt at the current event. Additionally or alternatively, if the customer has previously purchased tickets to similar events, the targeted message can be an advertisement for a similar future event.

For the purpose of illustration and not limitation, at 370, the customer can be directed to the merchant 110 to make a transaction corresponding to the targeted message. For example, as depicted in FIG. 2D, the customer device 270 can display an option to make a corresponding transaction through the customer device 270. Additionally or alternatively, the customer device 270 can display a promotion code, barcode, or QR code to make the transaction at the merchant location. Additionally or alternatively, the merchant device 110b can display the option to make the corresponding transaction through the merchant device 110b or display a promotion code, barcode, or QR code to make the transaction through another channel (e.g., elsewhere at the merchant location or through the merchant's website).

Additionally, for example and not limitation, at 375, the customer profile can be updated if the customer makes a transaction corresponding to the targeted message. Additionally or alternatively, the customer profile can be updated if the customer does not make a transaction after being presented with the targeted message.

FIG. 5 is a block diagram illustrating further details of a representative computer system according to an illustrative embodiment of the disclosed subject matter.

The systems and techniques discussed herein can be implemented in a computer system. As an example and not by limitation, as shown in FIG. 5, the computer system having architecture 600 can provide functionality as a result of processor(s) 601 executing software embodied in one or more tangible, non-transitory computer-readable media, such as memory 603. The software implementing various embodiments of the present disclosure can be stored in memory 603 and executed by processor(s) 601. A computer-readable medium can include one or more memory devices, according to particular needs. Memory 603 can read the software from one or more other computer-readable media, such as mass storage device(s) 635 or from one or more other sources via communication interface 620. The software can cause processor(s) 601 to execute particular processes or particular parts of particular processes described herein, including defining data structures stored in memory 603 and modifying such data structures according to the processes defined by the software. An exemplary input device 633 can be, for example, a keyboard, a pointing device (e.g. a mouse), a touchscreen display, a microphone and voice control interface, or the like to capture user input coupled to the input interface 623 to provide data and/or user input to the processor 601. An exemplary output device 634 can be, for example, a display (e.g. a monitor) or speakers coupled to the output interface 624 to allow the processor 601 to present a user interface, visual content, and/or audio content. Additionally or alternatively, the computer system 600 can provide an indication to the user by sending text or graphical data to a display 632 coupled to a video interface 622. Furthermore, any of the above components can provide data to or receive data from the processor 601 via a computer network 630 coupled the communication interface 620 of the computer system 600. In addition or as an alternative, the computer system can provide functionality as a result of logic hardwired or otherwise embodied in a circuit, which can operate in place of or together with software to execute particular processes or particular parts of particular processes described herein. Reference to software or executable instructions can encompass logic, and vice versa, where appropriate. Reference to a computer-readable media can encompass a circuit (such as an integrated circuit (IC)) storing software or executable instructions for execution, a circuit embodying logic for execution, or both, where appropriate. The present disclosure encompasses any suitable combination of hardware and software.

In some embodiments, processor 601 includes hardware for executing instructions, such as those making up a computer program. As an example and not by way of limitation, to execute instructions, processor 601 can retrieve (or fetch) the instructions from an internal register, an internal cache 602, memory 603, or storage 608; decode and execute them; and then write one or more results to an internal register, an internal cache 602, memory 603, or storage 608. In particular embodiments, processor 601 can include one or more internal caches 602 for data, instructions, or addresses. This disclosure contemplates processor 601 including any suitable number of any suitable internal caches, where appropriate. As an example and not by way of limitation, processor 601 can include one or more instruction caches 602, one or more data caches 602, and one or more translation lookaside buffers (TLBs). Instructions in the instruction caches 602 can be copies of instructions in memory 603 or storage 608, and the instruction caches 602 can speed up retrieval of those instructions by processor 601. Data in the data caches 602 can be copies of data in memory 603 or storage 608 for instructions executing at processor 601 to operate on; the results of previous instructions executed at processor 601 for access by subsequent instructions executing at processor 601 or for writing to memory 603 or storage 608; or other suitable data. The data caches 602 can speed up read or write operations by processor 601. The TLBs can speed up virtual-address translation for processor 601. In some embodiments, processor 601 can include one or more internal registers for data, instructions, or addresses. This disclosure contemplates processor 601 including any suitable number of any suitable internal registers, where appropriate. Where appropriate, processor 601 can include one or more arithmetic logic units (ALUs); be a multi-core processor; or include one or more processors 601. Although this disclosure describes and illustrates a particular processor, this disclosure contemplates any suitable processor.

In some embodiments, memory 603 includes main memory for storing instructions for processor 601 to execute or data for processor 601 to operate on. As an example and not by way of limitation, computer system 600 can load instructions from storage 608 or another source (such as, for example, another computer system 600) to memory 603. Processor 601 can then load the instructions from memory 603 to an internal register or internal cache 602. To execute the instructions, processor 601 can retrieve the instructions from the internal register or internal cache 602 and decode them. During or after execution of the instructions, processor 601 can write one or more results (which can be intermediate or final results) to the internal register or internal cache 602. Processor 601 can then write one or more of those results to memory 603. In some embodiments, processor 601 executes only instructions in one or more internal registers or internal caches 602 or in memory 603 (as opposed to storage 608 or elsewhere) and operates only on data in one or more internal registers or internal caches or in memory 603 (as opposed to storage 608 or elsewhere). One or more memory buses (which can each include an address bus and a data bus) can couple processor 601 to memory 603. Bus 640 can include one or more memory buses, as described below. In particular embodiments, one or more memory management units (MMUs) reside between processor 601 and memory 603 and facilitate accesses to memory 603 requested by processor 601. In some embodiments, memory 603 includes random access memory (RAM). This RAM can be volatile memory, where appropriate. Where appropriate, this RAM can be dynamic RAM (DRAM) or static RAM (SRAM).

Moreover, where appropriate, this RAM can be single-ported or multi-ported RAM. This disclosure contemplates any suitable RAM. Memory 603 can include one or more memories 604, where appropriate. Although this disclosure describes and illustrates particular memory, this disclosure contemplates any suitable memory.

In some embodiments, storage 608 includes mass storage for data or instructions. As an example and not by way of limitation, storage 608 can include a hard disk drive (HDD), a floppy disk drive, flash memory, an optical disc, a magneto-optical disc, magnetic tape, or a Universal Serial Bus (USB) drive or a combination of two or more of these. Storage 608 can include removable or non-removable (or fixed) media, where appropriate. Storage 608 can be internal or external to computer system 600, where appropriate. In some embodiments, storage 608 is non-volatile, solid-state memory. In some embodiments, storage 608 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 608 taking any suitable physical form. Storage 608 can include one or more storage control units facilitating communication between processor 601 and storage 608, where appropriate. Where appropriate, storage 608 can include one or more storages 608. Although this disclosure describes and illustrates particular storage, this disclosure contemplates any suitable storage.

In some embodiments, input interface 623 and output interface 624 can include hardware, software, or both, providing one or more interfaces for communication between computer system 600 and one or more input device(s) 633 and/or output device(s) 634. Computer system 600 can include one or more of these input device(s) 633 and/or output device(s) 634, where appropriate. One or more of these input device(s) 633 and/or output device(s) 634 can enable communication between a person and computer system 600. As an example and not by way of limitation, an input device 633 and/or output device 634 can include a keyboard, keypad, microphone, monitor, mouse, printer, scanner, speaker, still camera, stylus, tablet, touch screen, trackball, video camera, another suitable input device 633 and/or output device 634 or a combination of two or more of these. An input device 633 and/or output device 634 can include one or more sensors. This disclosure contemplates any suitable input device(s) 633 and/or output device(s) 634 and any suitable input interface 623 and output interface 624 for them. Where appropriate, input interface 623 and output interface 624 can include one or more device or software drivers enabling processor 601 to drive one or more of these input device(s) 633 and/or output device(s) 634. Input interface 623 and output interface 624 can include one or more input interfaces 623 or output interfaces 624, where appropriate. Although this disclosure describes and illustrates a particular input interface 623 and output interface 624, this disclosure contemplates any suitable input interface 623 and output interface 624.

As embodied herein, communication interface 620 can include hardware, software, or both providing one or more interfaces for communication (such as, for example, packet-based communication) between computer system 600 and one or more other computer systems 600 or one or more networks. As an example and not by way of limitation, communication interface 620 can include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 620 for it. As an example and not by way of limitation, computer system 600 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, computer system 600 can communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 can include any suitable communication interface 620 for any of these networks, where appropriate. Communication interface 620 can include one or more communication interfaces 620, where appropriate. Although this disclosure describes and illustrates a particular communication interface, this disclosure contemplates any suitable communication interface.

In some embodiments, bus 640 includes hardware, software, or both coupling components of computer system 600 to each other. As an example and not by way of limitation, bus 640 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 640 can include one or more buses 604, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within its spirit and scope.

1. A method for presenting targeted messages, comprising:
initiating a transaction with a cardholder to purchase an item;
receiving a selection from the cardholder to obtain the item at a merchant location;
receiving information identifying a customer who will obtain the item at the merchant location;
verifying, at the merchant location, an identity of the customer based at least in part on the information identifying the customer;
providing, at the merchant location, the item to the customer; and
presenting, at the merchant location, a targeted message to the customer based on a customer profile corresponding to the customer.

2. The method of claim 1, wherein the cardholder is the customer.

3. The method of claim 1, wherein initiating the transaction comprises at least one of:
receiving transaction information from the customer over an electronic network;
receiving the transaction information from the customer via a merchant website over the internet; or
receiving transaction information from the customer over a telephone network using one of mail order, telephone order or interactive voice response.

4. The method of claim 1, wherein initiating the transaction comprises initiating a transaction at a merchant terminal,
wherein receiving the selection from the cardholder to obtain the item at the merchant location comprises receiving a selection to obtain the item at the merchant location at a later time, and
wherein the merchant terminal is at a second merchant location different than the first merchant location.

5. The method of claim 1, further comprising approving the transaction by transmitting an authorization request over a payment network and receiving a corresponding authorization response over the payment network.

6. The method of claim 1, further comprising enrolling the customer based at least in part on the information identifying the customer,
wherein enrolling the customer comprises obtaining biometric challenge information from the customer using at least one of a customer device, an issuer device, a service provider device, or a merchant device; and
storing the biometric challenge information.

7. The method of claim 6, wherein the biometric challenge information comprises at least one of a fingerprint, a photograph, a voice recording, or an iris scan.

8. The method of claim 6, wherein verifying the identity of the customer comprises:
obtaining the stored biometric challenge information corresponding to the customer from at least one of a service provider or an issuer;
requesting, at a merchant device, the customer to provide the biometric challenge information;
receiving, at the merchant device, the biometric challenge information from the customer; and
comparing the received biometric challenge information with the stored biometric challenge information to verify the identity of the customer.

9. The method of claim 1, wherein providing the item to the customer comprises providing the item to the customer using a merchant device.

10. The method of claim 1, wherein presenting the targeted message to the customer comprises at least one of:
displaying the targeted message on a customer device;
displaying the targeted message on a merchant device;
printing the targeted message for the customer at the merchant device; or
contacting at least one merchant employee to present the targeted message to the customer.

11. The method of claim 1, wherein the customer profile comprises at least one of a customer age, a customer sex, a customer occupation, and a customer purchase history.

12. The method of claim 1, further comprising:
obtaining the customer profile from at least one of a service provider or an issuer before presenting the targeted message to the customer based on the customer profile,
wherein the at least one of the service provider or the issuer updates the customer profile automatically each time the customer makes a transaction.

13. The method of claim 1, further comprising:
directing the customer to the merchant to make a transaction corresponding to the targeted message; and
updating the customer profile if the customer makes a transaction corresponding to the targeted message.

14. A system for presenting targeted messages, comprising:
a merchant computer system configured to initiate a transaction with a cardholder to purchase an item, receive a selection from the cardholder to obtain the item at a merchant location, and receive information identifying a customer who will obtain the item at the merchant location;
a merchant device at the merchant location configured to verify an identity of the customer based at least in part on the information identifying the customer, provide the item to the customer, and present a targeted message to the customer based on a customer profile corresponding to the customer.

15. The system of claim 14, wherein the merchant computer system is connected to a payment network, and further wherein the merchant computer system is further configured to generate an authorization request corresponding to the transaction with the cardholder, transmit the authorization request over the payment network, and receive an authorization response corresponding to the authorization request.

16. The system of claim 14, the merchant computer system is connected to a first network, and further wherein the merchant computer system is further configured to initiate the transaction with a cardholder device of the cardholder over the first network.

17. The system of claim 16, wherein at least one of:
the merchant device is connected to the first network, and the merchant device is further configured to transmit a request over the first network to a customer device of the customer for the customer to provide the information identifying the customer and receive the information identifying the customer from the customer device; or
the merchant device is connected to a second network, and further wherein the merchant device is further configured to transmit a request over the second network to a customer device of the customer for the customer to provide the information identifying the customer and receive the information identifying the customer from the customer device.

18. The system of claim 14, wherein:
wherein a service provider server is configured to store biometric challenge information corresponding to the information identifying the customer,
wherein the merchant device is further configured to obtain the stored biometric challenge information from the service provider server corresponding to the information identifying the customer, and
wherein the merchant device is further configured to verify the identity of the customer by comparing biometric challenge information received from a customer device to the stored biometric challenge information corresponding to the information identifying the customer obtained from the service provider server.

19. A network for presenting targeted messages, comprising:
a cardholder device of a cardholder;
a merchant computer system configured to initiate a transaction with a cardholder device to purchase an item, receive a selection from the cardholder device to obtain the item at a merchant location, and receive from the cardholder device information identifying a customer who will obtain the item at the merchant location;
a customer device of the customer; and
a merchant device at the merchant location configured to verify an identity of the customer based at least in part on the information identifying the customer and information from the customer device, provide the item to the customer, and provide a targeted message to the customer device based on a customer profile corresponding to the customer,
wherein the customer device is configured to present the targeted message to the customer.

20. The network of claim 19, wherein the merchant computer system is further configured to generate an authorization request corresponding to the transaction with the cardholder and transmit the authorization request over a payment network, further comprising:
at least one acquirer connected to the payment network, the merchant computer system in communication with at least one of the at least one acquirer via the payment network;
at least one issuer connected to the payment network, each acquirer in communication with at least one of the at least one issuer via the payment network, the at least one issuer configured to receive the authorization request over the payment network and transmit a corresponding authorization response over the payment network;
at least one service provider server connected to the payment network and configured to automatically store purchase information corresponding to each authorization request and corresponding authorization response over the payment network and to update a corresponding customer profile with the purchase information.
